(19) United States
(12) Patent Application Publication
(10) Pub. No.: US 2009/0095267 A1
(43) Pub. Date: Apr. 16, 2009

(54) MAGNETIC APPARATUS COMPRISING VANES AND GROOVES FOR THE TREATMENT OF SUPPLY FUELS

(76) Inventor: Alfonso Fernandez De La Torre, Mexico (MX)

Correspondence Address: FULBRIGHT & JAWORSKI, LLP, 1301 MCKINNEY, SUITE 5100, HOUSTON, TX, 77010-3095, US

(21) Appl. No.: 11/814,947

(22) PCT Filed: Mar. 3, 2005
(86) PCT No.: PCT/MX05/00016

§ 371 Date: Jul. 3, 2008

(51) Int. Cl. F02M 27/04

(52) U.S. Cl. 123/538

(57) ABSTRACT

The inventive apparatus relates to a magnetic apparatus comprising vanes and grooves for fuel supply treatment. The inventive apparatus consists of a tubular device which is installed in the fuel supply line and which houses a second tube. According to the inventive apparatus, the second tube in turn contains a series of magnets with opposing poles and is surrounded by a helical sheet or vanes, said inner tube and the helical sheet or vanes being equipped with holes and micro holes, and grooves, in order to generate a centrifugal action in the fuel while its molecules are polarized by the magnets.

### CROSS-REFERENCE TO RELATED APPLICATIONS

This Application is the National Phase Application of International Application No. PCT/MX2005/000016, filed Mar. 3, 2005.

### TECHNICAL FIELD

The magnetic apparatus comprising vanes protected by this invention is a magnetic, mechanic and ionizing device to treat fuel supply and improve its combustion increasing its utilization and reducing pollutant emissions. This magnetic apparatus comprising vanes and grooves for the treatment of supply fuels is made with a device that performs a magnetic and mechanical process of counter-polarizing and centrifuging that accomplishes the fracturation, ionization and ordering of the hydrocarbon fuel molecular chain. It may be used in any fuel device or equipment like boilers, furnaces, heaters, stoves, internal combustion engines, etc. It can be employed in the industry and in commerce in general.

### BACKGROUND OF THE INVENTION

There are products that only ionize, which produce no more than 4% savings. Also, there are merely mechanic apparatus that sometimes accomplish molecular chain breaking reaching a maximum of 2% savings. For example, U.S. Pat. No. 5,664,546 refers to a non magnetic body, around a fuel tube with internal magnets including an economizer with two halves made of non magnetic material bound together like a shell keeping them tight around the fuel tube. Patent EP 0852291 proposes a body placed around the fuel tube, made of a neutral material containing a series of magnets.

In said patent, a single magnetic field is created, unlike this invention, where the apparatus comprising vanes and grooves for treatment of supply fuels surprisingly proposes a multimagnetic field by creating lots of magnetic fields. Also, It has holes on the vanes and grooves in the energetic center as well as a hole that allows an increasing its power effect.

The magnetic apparatus comprising vanes and grooves for fuel supply treatment claimed in this invention, combines mechanics and magnetism. Because of the counter polarized magnets action, it can accomplish molecular breaking, alignment, ionization and centrifugation thus accomplishing amazing results of energy savings of up to 20 to 25%

Additionally, to the holes, it features micro holes in the vanes and grooves for the treatment of supply fuels inside the energetic center that can surprisingly increase the apparatus power.

Currently, there is a connection between fuel containers and the machines or equipment that use them without any kind of ionizing magnetic-mechanic process to improve combustion. In some cases the fuel is filtered only to avoid impurities, which does not imply any kind of ionization or fuel savings. It only protects the integrity and good functioning of the machine or equipment.

There is currently no apparatus in the market with vanes and grooves for the treatment of supply fuels with a device performing a magnetic, mechanic, counter polarized and centrifugal action to accomplish breaking, ionization and ordering of the hydrocarbon fuel molecular chain or a similar fuel device to the one claimed in this inventive apparatus. Nor is there any apparatus that, under the same principle can offer the amazing benefits of fuel use and pollutant emissions reduction. This apparatus is the result of years of studies and tests resulting in average fuel savings of 20 to 25% and at least a 40% decrease of pollutant emissions.

### BRIEF SUMMARY OF THE INVENTION

The apparatus comprising vanes and grooves for fuel supply treatment features the following benefits: I) no maintenance is needed, II) it is quickly and inexpensively installed, III) it may be used with any kind of hydrocarbon-derived fuels and in any device or equipment IV) it increases flame temperature in machines or equipments that produce it.

The present invention was ruled by the following technical principles:

A liquid or gaseous fuel is made by a series of molecules.

Each molecule includes a number of atoms which hold a nucleus and electrons orbiting around it. Molecules by themselves, have magnetic momentum and electrons' orbiting originates a magnetic phenomenon. Thus, within the fuel molecules there are positive and negative charges. When the negative and positive particles are not changed into finer particles when combining with oxygen during combustion, they generate an incomplete combustion. Considering that fuels mainly consist of hydrocarbons, and that when they flow together through a magnetic field, they change the magnetization of their orientation in opposite direction to the one of the magnetic field, it is possible to break the hydrocarbon molecules changing their configuration with endless magnetic fields improving their combustion.

The apparatus comprising vanes and grooves for treatment of supply fuels creates a magnetic field that ionizes the fuel thus assuring a better combustion that result in fuel savings and pollutant emissions reduction.

Additionally, it features micro holes in the vanes and grooves inside the energetic center, as well as holes or micro holes allowing to amazingly increasing the device's power.

When holes are added to the vanes, liquid or gaseous fuel passes where the flow will crash against the mediate vane increasing fuel turbulence inside the apparatus. This turbulence will attain a longer residence time causing more intermolecular slackening, which brings amazingly increased efficiency.

Additionally to obtaining the above mentioned effects, the grooves in the energetic center, due to the slope cut in the fuel pass, will also produce an ultrasound benefiting the molecular slackening and the more slackening, the better the combustion. Surprisingly, this allows fuel savings.

In the case of thicker liquid fuel, instead of vanes, a metallic spiral superconductor is installed. It may be made of copper, bronze, strontium or a combination of them. It will allow fuel to easily pass resulting in a better molecular slackening. Like this, results are achieved in fuel savings and amazingly, gas-oil or combustion oil devices do not clog.

At the same time, the intermolecular force is considerably reduced. This mechanism helps fuel particles scattering until finally divided. Additionally fuel hydrogen ions and air oxygen ions are magnetized to help atomize fuel into thin particles.

The resulting condition is a mixture fuel-air magnetized in opposed polarities that is completely burned producing higher flame temperature, more economies and environment pollutants reduction.

The apparatus comprising vanes and grooves for fuel supply treatment used with hydrocarbons like natural gas, LP-gas, gasoline, diesel, combustion-oil, gas-oil, etc., is capable of efficiently improving their combustion in order to meliorate utilization and reduce pollutants emission. Details of this apparatus are clearly illustrated in the following description and enclosed drawings with reference signs to point its pieces and figures.

### BRIEF DESCRIPTION OF THE DRAWINGS

For a more complete understanding of the present invention, reference is now made to the following descriptions taken in conjunction with the accompanying drawing, in which:

FIG. 1 shows a cylinder screw-shaped apparatus comprising vanes and grooves;

FIG. 2 shows an alternate cylinder shaped, flanged with iron body apparatus comprising vanes and grooves;

FIG. 3 shows a cylinder's mouth of FIG. 2;

FIG. 4 shows the apparatus of FIGS. 1 and 2 consisting on a copper sheet tube;

FIG. 5 shows a copper pipe with a tubular device;

FIG. 6 shows a copper pipe with a tubular device; and

FIG. 7 shows the inside of another copper pipe.

### DETAILED DESCRIPTION OF THE INVENTION

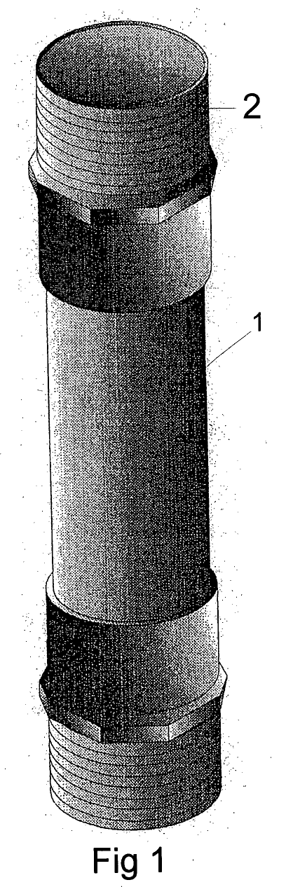

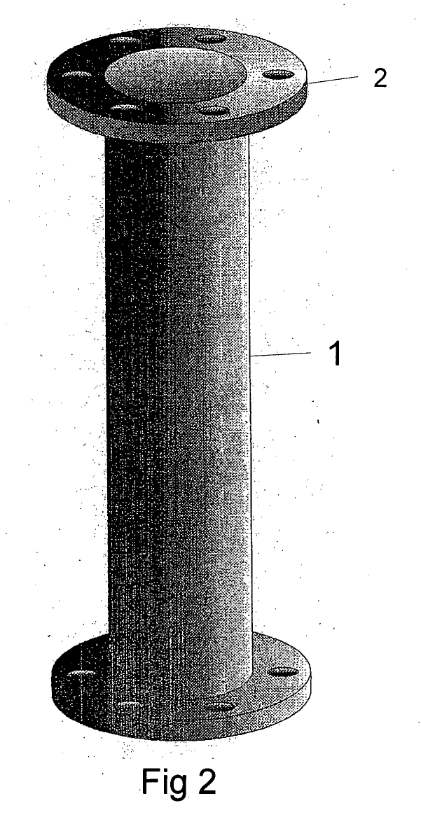

This inventive apparatus comprising vanes and grooves for treatment of supply fuels features in its external part (FIGS. 1 and 2) A cylinder shape to fit any kind of tube and is available in two versions:

1.—(Screw-shaped): with copper body (FIG. 1. no. 1) and screw shaped terminals (FIG. 1 no. 2) for two inch or wider tubes and for 0 to 10000 fuel liter volumes.

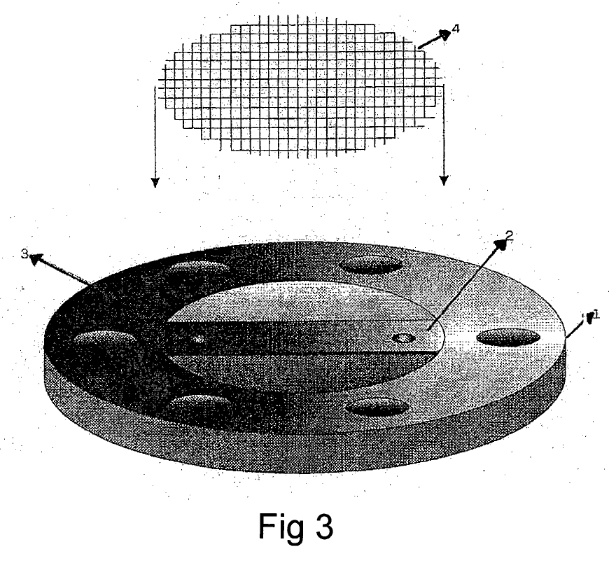

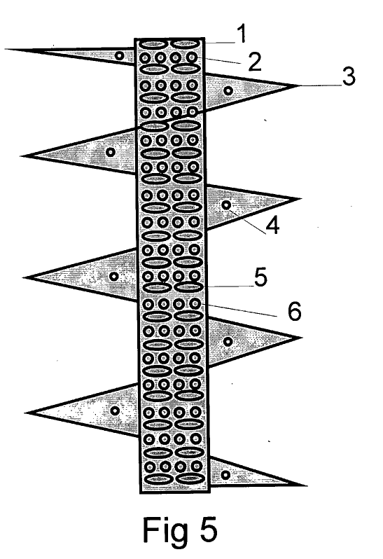

2.—(Flanged) with iron body (FIG. 2 no. 1) and same material flanges (FIG. 2 no. 2) certificate's minimum 40 and 150 pound flanges for two inch or wider tubes and for a 5000 m3 and up to 15 million m3 volume, the mentioned cylinder's mouth (FIG. 3 no. 1) has a half inch crossbeam string piece to prevent the internal mechanism from moving. It also has holes (FIG. 3 no. 3) to fasten a protection net (FIG. 3. no. 4) made of a copper pipe (FIG. 5 no. 1), with a tubular device of approximately 25% of its diameter which is the ionization center.

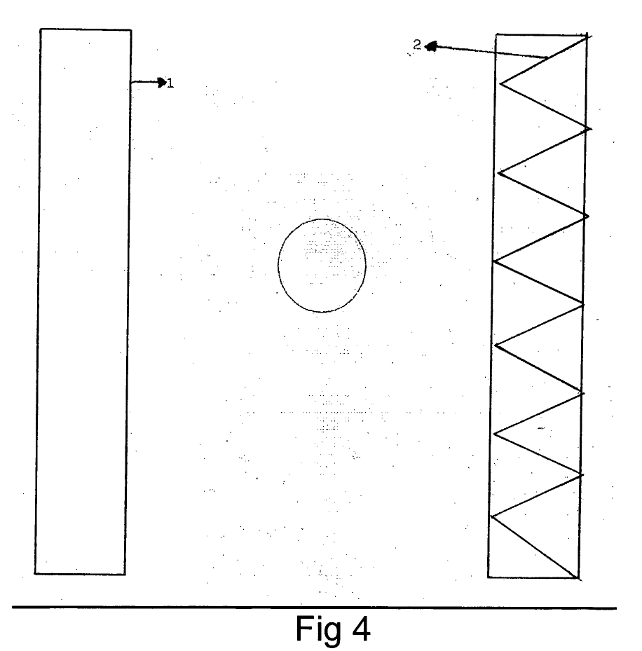

The internal structure can be seen in FIGS. 4, 5, 6 y 7.

FIG. 4 represents the apparatus consisting on a copper sheet tube (FIG. 4 no. 1) with a plastic helical sheet or vanes, or a spiral made of superconductive metal (FIG. 4 no. 2) inserted in the housing like a jacket.

FIG. 5 represents a copper pipe (FIG. 5 no. 1) with a tubular device of approximately 25% of its diameter. This is the ionization center where a series of powerful opposing poles accomplish the fuel ionization, the vanes ((FIG. 5 no. 3) have micro vanes (FIG. 5 no. 4) that will allow liquid or gaseous fuel to pass where the flow will crash against the mediate vanes causing higher fuel turbulence. This turbulence will result in a longer residence time achieving higher intermolecular slackening and more effectiveness. The grooves in the energetic center (FIG. 5 no. 5) and the micro holes (FIG. 5 no. 6) allow the above mentioned effects. The cut slope at the fuel pass, produces an ultrasound that increases the power for molecular slackening too. The copper tube (FIG. 5 no. 1) has in its body a series of micro holes (FIG. 5 no. 6) which permit breathing so that the passing fuel is sent outside.

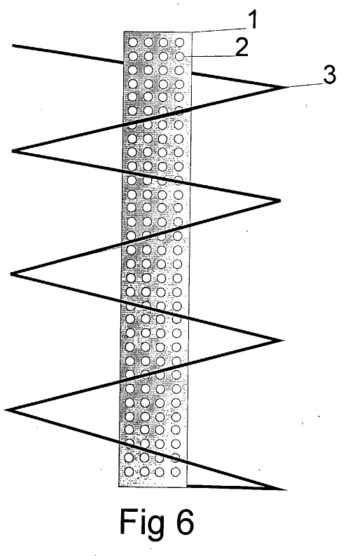

FIG. 6 represents a copper pipe (FIG. 6 no. 1) with a tubular device of approximately 25% of its diameter. This is the ionization center. It has micro holes (FIG. 6 no. 2) and it also carries a laminated sheet of superconductive metal (FIG. 6 no. 3) with a rivet spiral shaped flexible magnet for the hydrocarbons molecular chain reordering. When there is higher power, spirals have a shorter spiral pass. When it is for low consumption, the pass is longer. Just as the external diameters are calculated according to consumption levels, so is the center.

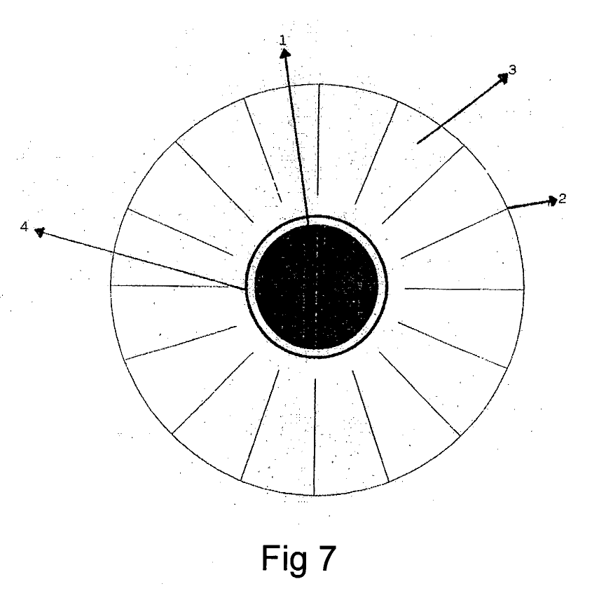

FIG. 7 represents a copper pipe (FIG. 7 no. 1) where tubular device is of approximately 25% of its diameter. This is the ionization center and is surrounded by a superconductive metal (FIG. 7 no. 4) and it is also cut in thousands of vanes (FIG. 7 no. 3) allowing higher fuel friction and residence in the cylinder as well as more friction against the vanes producing hydrocarbon molecular chains slackening. It has a superconductive metal sheet (FIG. 7 no. 2) with a spiral shaped flexible magnet rivet to reorder the hydrocarbon molecular chain. When there is higher power, spirals are tighter and if there is low power they are wider. External diameters are calculated according to consumption and so is the center.

The invention is built by placing inside the cylinder (external part) a copper tube with plastic spiral magnet which remains inserted in the housing like a jacket. The copper tube is covered with superconductive metal laminated spiral rivets with one inch magnets. This is then placed in the cylinder that already has the laminated tube affixed as a jacket. Finally, the protective net is rivet to the string piece found in the cylinders' mouth to prevent the internal part from moving.

The apparatus with vanes and grooves for treatment of hydrocarbon supply fuels works as follows: hydrocarbon chemical chains have a specific tension. When this superficial tension is broken leaving ordered, ionized and broken chains, these are placed into the apparatus mechanical and bipolar centrifugal action achieving a better combustion and thus, significant savings and low pollutant emissions.

The advantages of hydrocarbon fuel savers are: reduction in fuel consumption and reduction of pollutant emissions.

### EXAMPLE

The apparatus comprising vanes and grooves for treatment of supply fuels was tested. Fuel was treated during a 20 day period before the device with the following features was installed: micro holes with 2 mm vanes and grooves or 3 cm by 1 cm height.

Run kilometers: 4,798.27

PLG liters consumed: 671.08

Fuel performance: 7.15 km/lt

Savings obtained: 20% to 25%

The fuel treatment apparatus with vanes and grooves placed in the same vehicle was assessed during a 30 day period showing the following results:

Run kilometers: 6,915.59

PLG liters consumed: 862.29

Fuel performance: ̂0.02 km/lt (sic)

Fuel performance improved by 16.16% to 19%.

1. An apparatus comprising vanes and grooves for treatment of supply fuels features a copper sheet tube with plastic magnet placed on the housing like a jacket, a copper pipe with a tubular device of approximately 25% of its diameter where a series of encountered high power magnets perform fuel ionizing, additionally, it has micro holes on the vanes and grooves in the energetic center; the copper tube has in its body a series of micro holes allowing it breathing and friction so that the fuel passing though it is sent outside.

2. An apparatus with vanes and grooves for treatment of supply fuels according to the claim: 1, wherein by its micro holes on the vanes allowing fuel pass, the fuel crashes against the mediate vanes causing increased fuel turbulence and achieving longer residence time which results in higher molecular slackening.

3. An apparatus with vanes and grooves for treatment of supply fuels, according to the claim, 1 characterized by wherein its grooves in the magnetic center and by the slope cut in the fuel pass that produces an ultrasound that increases molecular slackening

4. An apparatus with vanes and grooves for treatment of supply fuels, according to the claim 1, wherein its copper tube is wrapped by superconductive metal sheet and is cut into thousands of vanes. The cylinder features a superconductive metal sheet with a rivet flexible spiral magnet.

5. An apparatus with vanes and grooves for treatment of supply fuels according to claim 1, is wherein spirals are made according to the power needed, with a thinner pass when power is high and a longer pass for low consumption.
